(19) United States
(12) Patent Application Publication
(10) Pub. No.: US 2025/0361764 A1
(43) Pub. Date: Nov. 27, 2025

(54) UNIVERSAL JAMB ASSEMBLY

(71) Applicant: FUTURO KOZIJNEN B.V., Hoofddorp (NL)

(72) Inventors: Sherwin Remigio WIESKE, Doetinchem (NL); Johannes Petrus Nicolaas NEEFJES, Doetinchem (NL)

(73) Assignee: FUTURO KOZIJNEN B.V., Hoofddorp (NL)

(21) Appl. No.: 18/996,874

(22) PCT Filed: Jul. 13, 2023
(86) PCT No.: PCT/NL2023/050376

§ 371 Date: Jan. 17, 2025

(30) Foreign Application Priority Data
Jul. 20, 2022 (NL) 2032559

(51) Int. Cl. E06B 1/52; E06B 1/06

(52) U.S. Cl. CPC E06B 1/526; E06B 1/06

(57) ABSTRACT

The invention provides a universal jamb assembly for a door casing, comprising two jambs having an identical cross section for making them universal for placement as hinge-side jamb or as strike-plate-side jamb of the door casing and each having a wall side and a door side face, and
two elongated mounting strips, the elongated mounting strips having a jamb-facing face matching at least part of the door side face, one of the elongates mounting strips provided with at least two hinge leave recesses for allowing hinge leave mounting and the other elongated mounting strip provided with a strike plate recess for allowing strike plate mounting, the elongated mounting strips and the jambs mutually adapted to be coupled with the elongated mounting strip being applied onto the jamb from a direction substantially normal to the longitudinal axis of the jamb, and the jamb made of wood or wood-replacing composition.

### FIELD OF THE INVENTION

The invention relates to a universal jamb assembly for a door casing, and a method for producing a door frame in an opening in a wall.

### BACKGROUND OF THE INVENTION

U.S. Pat. No. 3,774,345 according to its abstract describes: “An extruded metal jamb of a door casing is formed with a channel shaped elongated support member having a pair of laterally spaced and longitudinally extending guides. A plurality of hinge leaf mounting plates are slidably mounted to the channel guides for longitudinal adjustment relative to each other and to the door jamb so that hinge leaves may be fixed to the mounting plates and the assembly of hinge leaf and mounting plate fixedly secured to the jamb. The adjustable mounting of the hinge leaves to the jamb enables much simplified installation of a door having factory mortised hinge leaves. The extruded jamb section is formed with longitudinally extending laterally spaced slots for ready securement of either a cover or a strike plate or both, so that the jamb is readily applicable to either side of the door opening. Several types of adjustable hinge leaf mounting plates and cover sections are shown.”

U.S. Pat. No. 2,910,154 introduces: “This invention relates to metal door frames and is directed particularly to constructions adapted to be formed from extruded metal strips.”

### SUMMARY OF THE INVENTION

A disadvantage of prior art is that despite the fact that the cited art is almost 50 and 70 years old, installing door frame assemblies still often requires machining on-site. Furthermore, errors can be made, making jambs unusable. These errors can be made during measuring, production, installing.

Hence, it is an aspect of the invention to provide an alternative door frame assembly, which preferably further at least partly obviates one or more of above-described drawbacks.

There is provide a universal jamb assembly for a door casing, comprising two jambs having an identical cross section for making them universal for placement as hinge-side jamb or as strike-plate-side jamb of the door casing and each having a wall side and a door side face, and
two elongated mounting strips, the elongated mounting strips having a jamb-facing face matching at least part of the door side face, one of the elongates mounting strips provided with at least two hinge leave recesses for allowing hinge leave mounting and the other elongated mounting strip provided with a strike plate recess for allowing strike plate mounting, the elongated mounting strips and the jambs mutually adapted to be coupled with the elongated mounting strip being applied onto the jamb from a direction substantially normal to the longitudinal axis of the jamb, and the jamb made of wood or wood-replacing composition.

There is further provided a method for producing a door frame in an opening in a wall, comprising providing the universal jamb assembly, further comprising
fixing the jambs in the opening in the wall, applying one of the elongated mounting strips on one of the jambs, placing the hinge leave substantially flush in the hinge leave recess and fixing the hinge leave on both the elongated mounting strip and on the jamb;
mounting the other mounting strip one the other jamb, placing the strike plate substantially flush in the strike plate recess and fixing the strike plate on both the mounting strip and on the jamb.
mounting the other mounting strip one the other jamb, placing the strike plate substantially flush in the strike plate recess and fixing the strike plate on both the mounting strip and on the jamb

The posts and mounting strips can be of wood or of a wood-replacing composition.

These wood-replacing materials are all well known. Examples are foam-core polymer materials. These are well known in the art. Other examples are polymer-fiber mixtures, in some instance comprising wood fibers or other fiber material.

Most of the polymer material is thermoplastic. The polymer material in an embodiment is may be bio-based, in some applications even be or comprise bio-degradable or compostable material. In an embodiment, bioplastics can be used. These can be based on for instance polylactic acid polymers, polyhydroxyalkanoates, or even starch blends, cellulose-based polymers, lignin-based polymers, and many comparable polymers.

In particular, this material enables a common wood screw to be directly inserted into the material, like in wood.

The current case in particular relates to doorways. A doorway comprises a doorframe or door casing (door case), and a wing, usually a door. Once installed, a door frame comprises a horizontal upper section or lintel, and two opposite door posts or jambs. Once installed, one vertical jamb is here defined as the hinge-sided jamb, holding the door hinges. The opposite jamb is referred to here as receiving jamb. This is based upon the fact that this jamb usually has holes for receiving either a latch, a dead bolt, or both. This side is usually provided with a strike plate with one or two openings or passages for the latch and/or deadbolt and/or door bolt.

In one instance of the jambs, one jamb is placed and the other first 180 degrees rotated, i.e., the other side is up with respect to the placed jamb, and that that second jamb is placed and mounted and fixed.

The current assembly allows blind mounting of the door frame, allowing to cover all mounting elements, like screw heads.

In an embodiment, the elongates mounting strips have a mounting strip width and a mounting strip thickness, with the mounting strip width being at least 6 times larger than the mounting strip thickness, in particular at least 10 times larger.

In an embodiment, the elongates mounting strips have a substantially rectangular cuboid shape.

In an embodiment, the mounting strips have a strip mounting length and the jambs have a jamb mounting length, wherein the mounting strip mounting length and the jamb mounting length are substantially the same.

In an embodiment, each mounting strip has the hinge leave recesses in one surface and the strike plate recess in its opposite surface, in particular the mounting strips are identical. This can provide one universal mounting strip. In another embodiment, there could even be a mounting strip version having hinge leave recesses on both sides. In this way, different configurations might be handled. In another embodiment, these recesses on one side are mirrored with respect to the other side. This might obviate turning and rotating the strip, there is always a right side. The same holds for a mounting strip with strike plate recesses on both sides.

In an embodiment, the jambs have a jamb length and comprise a slot in the door facing face for receiving a bolt and covering center of the length of the jamb, in particular the slot extending at least 5 cm from the center, more in particular having a slot length of at least 10 cm. this would make the slot universally usable.

In an embodiment, the jamb assembly is adapted for a flush door, wherein the jambs comprise door stop ledges.

In an embodiment, the universal jamb assembly comprise hinges having a hinge leave having a hinge leave thickness, wherein hinge leave recess have a profile and depth adapted for flush mounting of hinge leaves.

In an embodiment, the universal jamb assembly comprises strike plate, and wherein the strike plate recess is adapted for allowing flush mounting of strike plate.

In an embodiment, the jamb is substantially solid, in particular from wood or a polymer material, in an embodiment having a foamed core.

In an embodiment, the universal jamb assembly further comprises at least one moulding of coving for providing an architrave, wherein the coving comprises a rim extending in longitudinal direction and extending away from the further coving, and wherein at least one of the jambs has a wall side and adjacent sides, at least one adjacent died comprising a longitudinal groove dimensioned for receiving the rim of the coving.

There is alternatively provided a universal jamb assembly for a door casing, comprising two jambs having an identical cross section for making them universal for placement as hinge side jamb or as strike plate side jamb of the door casing and each having a wall side and a door side face, and two elongated mounting strips, the elongated mounting strips having a jamb-facing face matching at least part of the door side face, one of the elongates mounting strips provided with at least two hinge leave recesses for allowing hinge leave mounting and the other elongated mounting strip provided with a strike plate recess for allowing strike plate mounting

There is alternatively provided a universal jamb assembly for a door casing, comprising two jambs having an identical cross section for making them universal for placement as hinge side jamb or as strike plate side jamb of the door casing and each having a wall side and a door side face, and two elongated mounting strips, the elongated mounting strips having a jamb-facing face matching at least part of the door side face, one of the elongates mounting strips provided with at least two hinge leave recesses for allowing hinge leave mounting and the other elongated mounting strip provided with a strike plate recess for allowing strike plate mounting.

The current universal jamb assembly can clearly be used for in internal door as well as an external door. For an outer door, the strip might be from a resilient material like steel or reinforced polymer. After placement of the bolt sided mounting strip, usually one or two small holes for the latch and dead bolt need to be made in the mounting plate. This to penetrate the bottom of the strike plate recess. The strike plate already marks their shape and position.

For the strip of more resilient material, the cuboid shape provides additional advantages, like providing more safety to a doorpost of wood or wood-like or wood-replacing material.

There is also provided a jamb assembly comprising a jamb having a wall side, a door side and two opposite sides, the two opposite sides comprising a slot, the assembly further comprising a moulding or coving for providing an architrave for in use, the moulding comprising a ledge extending from the moulding and adapted for fitting into the slot.

In the above, there is provided a door frame and door. In an alternative embodiment, the current assembly can be adapted for a window assembly or other alternative building part with a frame and corresponding wing. For instance with a window with a hinge, the current jambs are a respective frame part holding hinges and a frame part having closure provisions. In particular, there is provided:

A universal frame assembly for a building, the frame assembly comprising a wing hingingly coupled to the frame, for instance a window, the universal frame comprising two opposite frame parts having an identical cross section for making them universal for placement as hinge side frame part and as locking plate side frame part of the frame, and each having a wall side and a wing side face, and two elongated mounting strips, the elongated mounting strips having a frame part-facing face matching at least part of the wing side face, one of the elongates mounting strips provided with at least two hinge leave recesses for allowing hinge leave mounting and the other elongated mounting strip provided with locking plate recess for allowing locking plate mounting.

The term “substantially” herein, such as in “substantially consists of”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices or apparatus herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

The invention further applies to an apparatus or device comprising one or more of the characterising features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a frontal view of a general doorway comprising a door casing or door frame and a wing, in particular a door;

FIG. 2 shows one side of a door frame;

FIG. 3 shows the opposite side, with reference to FIG. 2, of the door frame;

FIG. 4 illustrates a cross section through a mounted jamb;

FIG. 5 depicts a universal strip, and

FIG. 6 illustrates an alternative universal jamb in cross section.

The drawings are not necessarily on scale.

### DESCRIPTION OF PREFERRED EMBODIMENTS

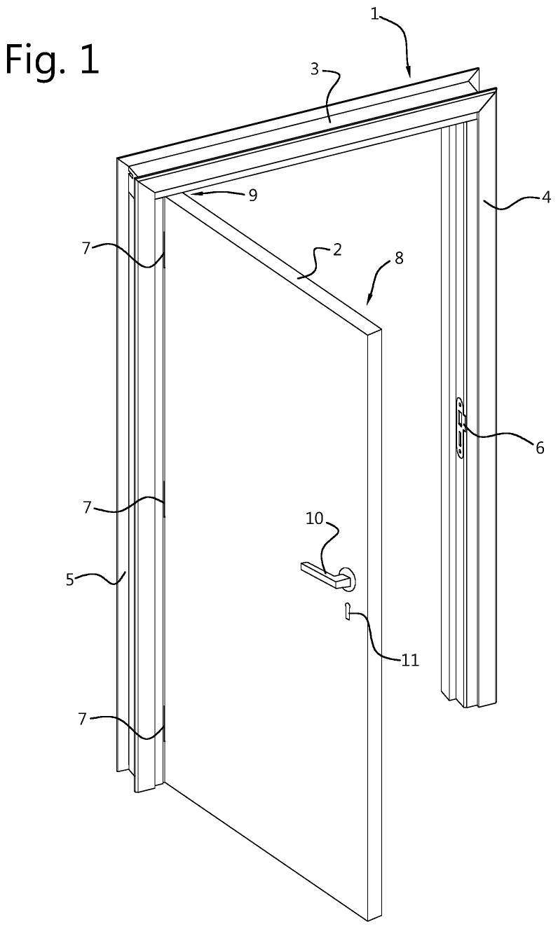

FIG. 1 schematically depicts a frontal view of a general doorway comprising a door casing or door frame 1 and a wing, in particular a door 2. FIG. 1 illustrates a flush-mounted door. The door frame 1 here comprises a horizontal door frame section 3 and two jambes 4, 5 opposite to on another. The door 2 has a hinge side 9 or hanging side having a hinge face. At its hinge side 9, the door 2 is attached via hinges 7 to one of the door posts or jambs 5. Furthermore, the door 2 has a bolt end 8 or closing side having a bolt face. At that end, the door 2 here comprises a handle 10 for operating a latch and a key hole 11 allowing insertion of a key for operating a dead bolt. The corresponding latch jamb 4 comprises a strike plate 6 here having two holes, one above the other, for receiving a latch and a dead bolt.

The jambs 5 each have a wall side that in a mounted state face a wall end of an opening in a wall of a building. The jambs 5 furthermore each have a door side face. These door side faces face the door 2 when it is closed. The horizontal door frame section 3 (sometimes referred to as ‘head post’ or ‘lintel’ if these is a window above the door) has a similar door side face and wall side face.

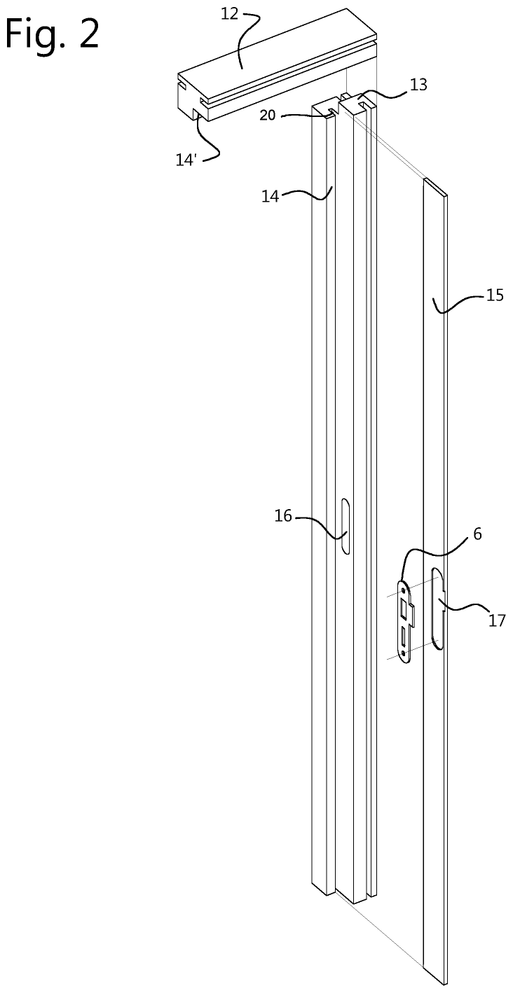

FIG. 2 illustrates one side of a door frame 1. It comprises a horizonal (upper) door frame section 12. A universal jamb 13 is depicted. The universal jamb 13 here comprises a door abutment ledge 14 for engaging a door 2, in particular stopping it in the door frame. In particular, this relates to a flush-mounted door 2. This provides a rabbet for the door 2.

The end of the jamb 13 is adapted to the profile of the horizontal door frame section 12. In use, in this way first the vertical door frame section may be placed and attached to an opening. When for instance mounted using mounting means, for instance using screws, at the ends of the horizontal door frame section 12, those mounting means can be covered by the jambs 5. Alternatively, the jambs 5 can first be attached to the horizontal door frame section, resulting in a door frame. Next, the door frame can be mounted in an opening in a wall.

The jamb 13 has a wall side face that can be similar to any known jamb 5. Opposite the wall side face the jamb 13 has its door side face, i.e. its face facing a side of the door. The jamb 13 has two further opposite sides that face away from the door 2.

The universal jamb 13 has a slot 16, the bolt receiving slot 16. It is often positioned mostly at the center of the length of the jamb 13. In that way, it will be positioned at a proper height no matter the orientation of the jamb 13.

The jambs 13 have a jamb length and comprise a slot 16 in the door facing face for receiving a bolt and/or latch and covering a center of the length of the jamb. In particular the slot extending at least 5 cm from the center. In an embodiment the slot has a slot length of at least 10 cm.

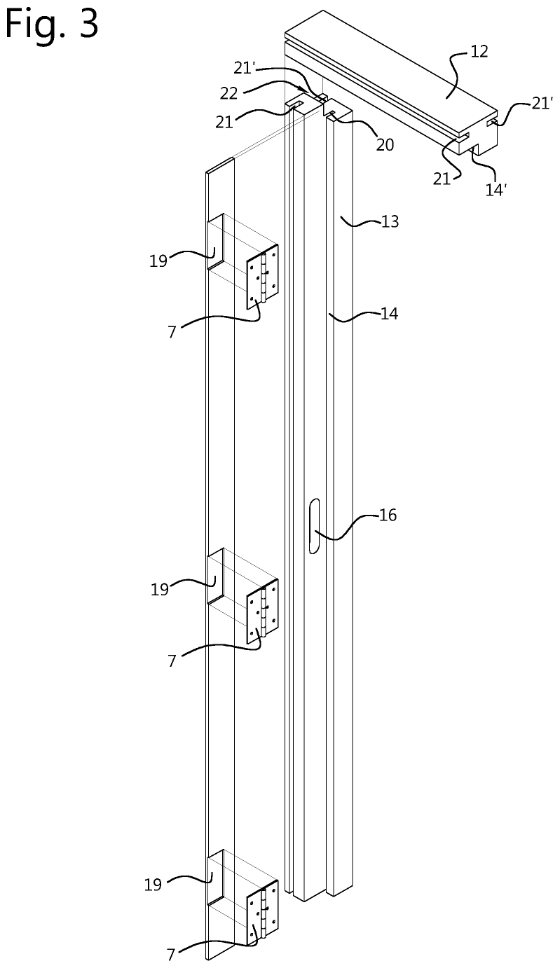

Starting at the center of the jamb 13, the bolt receiving slot mostly about 5-20 cm at both sides from the center. In this way, bolt receiving slot 16 is about 10-40 cm long. With that length, the bolt receiving slot 16 will be wide enough to receive a latch a well as a dead bolt, and this can be the case no matter which end of the jamb 13 is up. The width and depth of the bolt receiving slot 16 will be standardized and known to a skilled person. As illustrated also in FIG. 3, both opposite jambs 13 have the same bolt receiving slot 16 at the same relative position. Both jambs 13 of FIGS. 2 and 3 are a plane-mirror image from one another.

The universal door jamb assembly comprises a jamb 13 that is universal, and a mounting plate 15. The placement of mounting plate 15 in fact defines the jamb 13 as hinge side jamb 13 or bolt side jamb.

In the embodiment of FIGS. 2 and 3, there can be two distinct mounting plates 15. One mounting plate, illustrated in FIG. 3, is on a side provided with hinge leave recesses 19 or hinge leave notchings 19 for a hinge leave of a hinge 7. The other mounting plate 15 as illustrated in FIG. 2 has a strike plate recess 17 or a strike plate notching 17. Usually, the hinges 7 have a hinge leave. These have a hinge leave thickness. The hinge leave recess comprises a profile and depth adapted for flush mounting of hinges, in particular of a hinge leave.

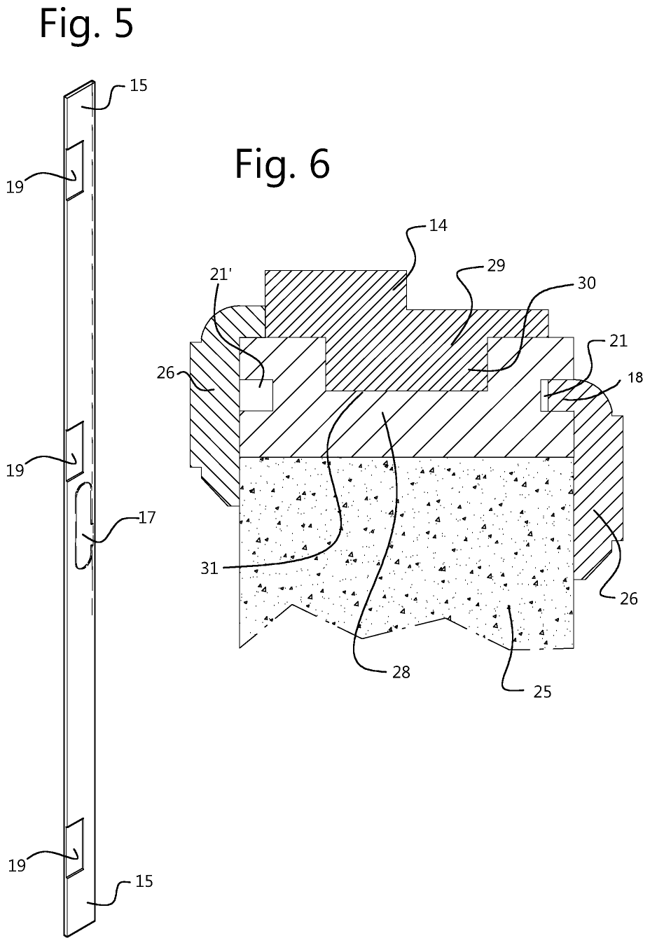

In FIG. 5 an embodiment is illustrated in which a mounting plate 15 has a hinge leave recess 19 on one side and a strike plate recess 17 on its opposite side. Rotating the mounting plate 15 twice allows changing of its functional side. Thus in such an embodiment, the mounting strips 15 are identical. Each mounting strip has the hinge leave recesses in one surface and the strike plate recess in its opposite surface.

In the depicted embodiment, the elongates mounting strips 15 have a substantially rectangular cuboid shape.

The elongates mounting strips 15 have a mounting strip width and a mounting strip thickness. In an embodiment, the mounting strip width is at least 6 times larger than the mounting strip thickness. In an embodiment, the width is at least 10 times larger.

Usually, the mounting strip 15 has a strip mounting length and the jamb 13 has a jamb mounting length. The mounting strip's 15 strip mounting length and the jamb's 13 mounting length are substantially the same.

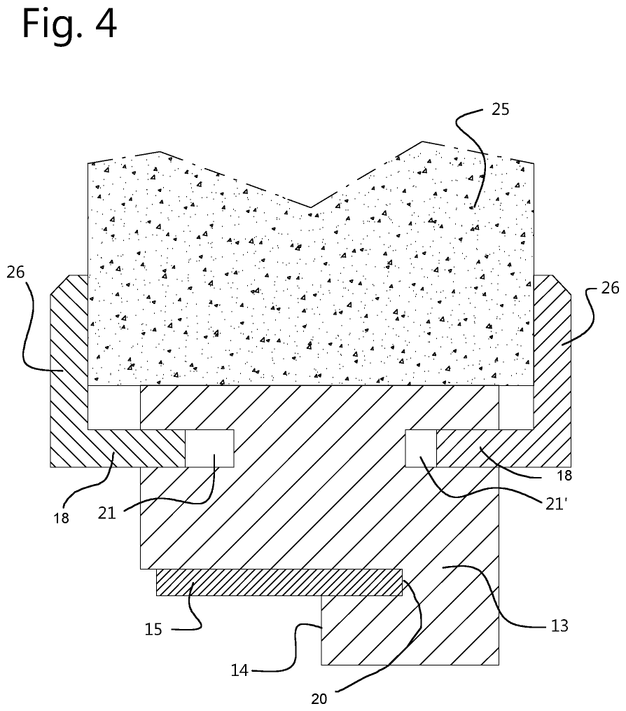

In the illustrated examples according to FIGS. 2-5, The mounting strip can be a strip with a rectangular cross section. The door-facing side of the jamb 13 dan have provisions for receiving the mounting strip 15. In the cross section of FIG. 4, this can be clarified. In the current embodiment of FIGS. 2 and 3, the jamb 13 comprises a slit 20 or mounting strip receiving groove 20. Such a slit 20 makes right mounting of the mounting strip 15 with respect to the jamb 13 easy. In another embodiment, instead of or in addition to the slit 20, the jamb 13 can comprise a recess allowing the mounting strip 15 to be mounted flush with a jamb surface.

The mounting strip can be of wood. For instance MDF is suitable. In an embodiment, the strip can be a metal strip. In this way, it can improve the security, making the doorpost more resistant against break and entry. For instance, allowing integration of a strike plate 6. In another embodiment, the strip can be of a mounded or extruded material, for instance of plastic or plastic or polymer matrix material having a filler material, like wood or silicon-based.

The current jamb 13 can also excellently be recycled and in particular be re-used, making it completely circular.

In FIG. 4, a cross section of a jamb 13 with mounted mounting plate 15 is illustrated. The wall side of the jamb 13 rests against the edge or the wall 25. The mounting strip 15 rests on the door facing surface of the jamb 13. The mounting strip is furthermore positioned in the slit 20. In an embodiment, not depicted, a recess can be made in the door facing surface in order to allow flush mounting of the mounting strip.

In an alternative embodiment, the jamb-facing side of the mounting strip 15 may comprise a profile matching a profile in the door facing surface of the jamb 13.

In FIG. 4, the jamb 13 comprises two opposite architrave rim receiving slots 21, 21′ or architrave rim grooves 21, 21′. In order to finish the transition from wall 25 to jamb 13, architrave strips 26 are known in the art in general. These architrave strips are also referred to as covings (UK) or mouldings. In the embodiment depicted in FIG. 4, the architrave strips 26 comprise an architrave rim 18. This rim 18 extends from the architrave strip 26. The rim 18 and slots 21, 21′ are mutually dimensioned such that the rim 18 fits sluggishly in a slot 21, 21′.

FIG. 6 shows an alternative universal jamb in cross section. Here the jamb 28 comprises a groove 31 or in an embodiment recesses 31. A special mounting strip 29 is presented that comprises an abutment ledge 14 for a flush door 2. The special mounting strip 29 comprises one or more extending ends 30 that match the groove 31 or recesses 31. In a simple embodiment allowing easy use, the jamb 28 is provided with a groove 31 that runs along the jamb 28.

The special mounting strip of FIG. 6 can be provided with the already described hinge leave recesses and strike plate recess. In such an embodiment there are two mounting strips, usually. On an embodiment, there is provided a further mounting strip, in an embodiment identical to the mounting strip 15. In the earlier-described manner, that mounting strip 15 can be incorporated after installing the special mounting strip 29. In such an embodiment, the special mounting strip 29 may comprise the slit 20 indicated earlier, for instance. The current embodiment allows selecting different materials for different functionalities, for instance. The mounting strip 15 can be metal, the special mounting strip 29 may be injection moulded or extruded with a small after treatment. The door abutment ledge 14 can for instance include bumpers or sealings.

In most embodiments, the jamb is substantially solid. Mostly, the jamb will be machined, or extruded. In many examples, the jamb will be from wood or a polymer material. In an example, the jamb can have a hollow or a foamed core. The current universal jamb allows production using extrusion and a simple addition of a standardized slot for latch and/or dead bolt.

There is further provided a jamb assembly further comprising at least one moulding of coving for providing an architrave, wherein the coving comprises a rim extending in longitudinal direction and extending away from the further coving, and wherein at least one of the jambs has a wall side and adjacent sides, at least one adjacent died comprising a longitudinal groove dimensioned for receiving rim of the coving.

Using the described universal jamb assembly, it provides a following method. A method for producing a door frame in an opening in a wall, comprising providing the universal jamb assembly according to any one of the preceding claims, further comprising
fixing the jambs in the opening in the wall, applying one of the elongated mounting strips on one of the jambs, placing the hinge leave substantially flush in the hinge leave recess and fixing the hinge leave on both the elongated mounting strip and on the jamb, and
mounting the other mounting strip one the other jamb, placing the strike plate substantially flush in the strike plate recess and fixing the strike plate on both the mounting strip and on the jamb.

For mostly hollow metal door frames, as is explained in the introduction with respect to the cited art, there are different options for making a door frame. The same holds for similar polymer and for instance fibre reinforced polymer based door frames known in the market. The currently proposed assembly is particularly suited for substantially massive jambs. Mostly, these are wooden jambs. In these jambs, usually the various provisions are already machined before arrival at an installation site. Furthermore, often the door frame is delivered as a complete part, making it more difficult to transport. The current door frame assembly can be delivered as a kit of parts comprising the universal jamb assembly, the horizontal door frame section, a door, hinges and a strike plate as a compact package that allows easy installing.

It will also be clear that the above description and drawings are included to illustrate some embodiments of the invention, and not to limit the scope of protection. Starting from this disclosure, many more embodiments will be evident to a skilled person. These embodiments are within the scope of protection and the essence of this invention and are obvious combinations of prior art techniques and the disclosure of this patent.

### REFERENCE NUMBERS

1 door frame assembly
2 door
3 upper or horizontal door frame section
4 traditional bolt side jamb
5 traditional hinge side jamb
6 bolt plate
7 door hinge
8 bolt end of a door
9 hinge side of a door
10 door handle for operating a latch or latch bolt
11 keyhole for operating the deadbolt, in short the bolt
12 vertical door frame section
13 universal jamb
14, 14′ door abutment ledge
15 mounting strip
16 bolt receiving slot
17 slot plate recess or strike plate recess or strike plate notching
18 architrave rim
19 hinge leave recess or hinge leave notching
20 mounting strip receiving groove
21, 21′ architrave rim receiving slot or architrave rim groove
22 jamb head profile matching vertical door frame section/toesteek
25 building wall
26 architrave or coving
28 universal jamb
29 mounting strip
30 mounting strip jamb coupling profile
31 jamb sided mounting strip coupling profile

1. A universal jamb assembly for a door casing, comprising two jambs having an identical cross section for making them universal for placement as hinge-side jamb or as strike-plate-side jamb of the door casing and each jamb having a wall side face and a door side face, and
two elongated mounting strips, the elongated mounting strips having a jamb-facing face matching at least part of the door side face, one of the elongated mounting strips provided with at least two hinge leave recesses for allowing hinge leave mounting and the other elongated mounting strip provided with a strike plate recess for allowing strike plate mounting, each of the the jamb-facing face of the elongated mounting strips and the door side face of the jambs mutually adapted to be coupled when the elongated mounting strip is applied onto the jamb from a direction substantially normal to the longitudinal axis of the jamb, and
wherein the jambs are made of wood or wood-replacing composition.

2. The universal jamb assembly according to claim 1, wherein the elongated mounting strips have a mounting strip width and a mounting strip thickness, with the mounting strip width being at least 6 times larger than the mounting strip thickness.

3. The universal jamb assembly according to claim 1, wherein the elongated mounting strips have a substantially rectangular cuboid shape.

4. The universal jamb assembly according to claim 1, wherein the elongated mounting strips have a strip mounting length and the jambs have a jamb mounting length, wherein the strip mounting length and the jamb mounting length are substantially the same.

5. The universal jamb assembly according to claim 1, wherein each elongated mounting strip has the hinge leave recesses in one surface and the strike plate recess in its opposite surface.

6. The universal jamb assembly according to claim 1, wherein the jambs have a jamb length and comprise a slot in the door facing face for receiving a bolt and covering center of the length of the jamb.

7. The universal jamb assembly according to claim 1, wherein the universal jamb assembly is adapted for a flush door, wherein the jambs comprise door stop ledges.

8. The universal jamb assembly according to claim 1, wherein the universal jamb assembly comprises hinges having a hinge leave having a hinge leave thickness, and wherein the hinge leave recesses have a profile and depth adapted for flush mounting of hinge leaves.

9. The universal jamb assembly according to claim 1, wherein the universal jamb assembly comprises strike plate, said strike plate comprising a strike plate recess, and wherein the strike plate recess is adapted for allowing flush mounting of strike plate.

10. The universal jamb assembly according to claim 1, wherein the jamb is substantially solid, in particular from wood or a polymer material, in an embodiment having a foamed core.

11. The universal jamb assembly according to claim 1, further comprising at least one coving for providing an architrave, wherein the coving comprises a rim extending in longitudinal direction and extending away from the further coving, and wherein at least one of the jambs has a wall side and adjacent sides, at least one adjacent side comprising a longitudinal groove dimensioned for receiving the rim of the coving.

12. A method for producing a door frame in an opening in a wall, comprising providing a universal jamb assembly for a door casing, comprising
two jambs having an identical cross section for making them universal for placement as hinge-side jamb or as strike-plate-side jamb of the door casing and each having a wall side face and a door side face, and
two elongated mounting strips, the elongated mounting strips having a jamb-facing face matching at least part of the door side face, one of the elongated mounting strips provided with at least two hinge leave recesses for allowing hinge leave mounting and the other elongated mounting strip provided with a strike plate recess for allowing strike plate mounting, the elongated mounting strips and the jambs mutually adapted to be coupled with the elongated mounting strip being applied onto the jamb from a direction substantially normal to the longitudinal axis of the jamb, and wherein the jambs are made of wood or wood-replacing composition,
and said method further comprising
fixing the jambs in the opening in the wall, applying one of the elongated mounting strips on one of the jambs in the opening in the wall, placing the hinge leave substantially flush in the hinge leave recesses and fixing the hinge leave on both the elongated mounting strip and on the jamb;
mounting the other mounting strip one the other jamb, placing the strike plate substantially flush in the strike plate recess and fixing the strike plate on both the mounting strip and on the jamb.

13. A kit of parts for a door frame, said kid of parts comprising a universal jamb assembly, said universal jamb assembly comprising
two jambs having an identical cross section for making them universal for placement as hinge-side jamb or as strike-plate-side jamb of the door casing and each having a wall side face and a door side face, and
two elongated mounting strips, the elongated mounting strips having a jamb-facing face matching at least part of the door side face, one of the elongated mounting strips provided with at least two hinge leave recesses for allowing hinge leave mounting and the other elongated mounting strip provided with a strike plate recess for allowing strike plate mounting, the elongated mounting strips and the jambs mutually adapted to be coupled with the elongated mounting strip being applied onto the jamb from a direction substantially normal to the longitudinal axis of the jamb, and wherein the jambs are made of wood or wood-replacing composition; a horizontal door frame section; a door; hinges; and a strike plate as compact package.
